(19) United States
(12) Patent Application Publication
(10) Pub. No.: US 2013/0142721 A1
(43) Pub. Date: Jun. 6, 2013

(54) LEWIS ACID SOLUTIONS IN AN OXYGEN DONOR-CONTAINING SOLVENT OR SOLVENT MIXTURE

(71) Applicants: Ulrich Wietelmann, Friedrichsdorf (DE); Alexander Murso, Liebenburg (DE); Sebastian Lang, Griesheim (DE)

(72) Inventors: Ulrich Wietelmann, Friedrichsdorf (DE); Alexander Murso, Liebenburg (DE); Sebastian Lang, Griesheim (DE)

(73) Assignee: Chemetall GmbH, Frankfurt Am Main (DE)

(21) Appl. No.: 13/634,327

(22) PCT Filed: Mar. 14, 2011
(86) PCT No.: PCT/EP2011/053788

§ 371 Date: Jan. 24, 2013

(30) Foreign Application Priority Data
Mar. 12, 2010 (DE) 10 2010 002 811.8

(51) Int. Cl. C09K 3/00

(52) U.S. Cl. CPC C09K 3/00
USPC 423/268

(57) ABSTRACT

The invention relates to solutions of Lewis acids selected from the halogen-containing Lewis acids of the elements of groups 12 and 13 from the periodic table of elements, or mixtures of said Lewis acids, in aprotic, asymmetrically substituted ethers or in solvent mixtures that contain asymmetrically substituted ethers and hydrocarbons, to the production of the solutions according to the invention, and to the use in inorganic, organic and organometallic syntheses.

The invention relates to Lewis acid solutions in asymmetrically substituted ethers or in solvent mixtures containing asymmetrically substituted ethers and hydrocarbons, preparation of the solutions according to the invention, and use of the solutions in inorganic, organic, and organometallic synthesis.

The invention further relates to solutions of halide compounds of elements of groups 8, 12, and 13 of the periodic table of the elements in asymmetrically substituted ethers, or in mixtures of asymmetrically substituted ethers and hydrocarbons.

Lewis acids find numerous applications in the area of chemical synthesis. By adding Lewis acids for example in Diels-Alder reactions, radical-mediated reactions, Friedel-Crafts alkylations or acylations, or aldol reactions, the yield of a synthesis reaction may be increased, and the regio-, enantio-, or diastereoselectivity of the corresponding reaction may optionally be controlled (H. Yamamoto, Lewis Acids in Organic Synthesis, Wiley-VCH, 2000, Volumes 1 and 2, and citations therein). In addition, Lewis acids find applications in the preparation of organometallic compounds, elemental hydrogen compounds (EHₓ), elemental hydrogen halide compounds, metal element hydrides, and complexed metal hydrides, for example in the preparation of organocopper or organozinc compounds, alane (AlH₃), chloroalanes (AlHₓCl₍₃₋ₓ₎), zinc borohydride, or lithium aluminum hydride (P. Knochel, P. Jones in Organozinc Reagents (Editors: L. M. Harwood, C, J. Moody), Oxford University Press Inc., New York, 1999, and citations therein; C. Elschenbroich, A. Salter, Organometallchemie [Organometallic Chemistry], Teubner, 1993, 3rd edition; A. J. Downs, C. R. Pulham, Chem. Soc. Rev. 1994, 175; A. E. Finholt, A. C. Bond, Jr., H. I. Schlesinger, J. Am. Chem. Soc, 1947, 69, 1199). Solutions of Lewis acids have the disadvantage that they decompose upon contact with trace amounts of water, so that the starting materials should have an extremely low water content in order to maximize the content of Lewis acids in the solutions. Halogen-containing Lewis acids are also frequently used as raw materials for preparing organosubstituted or also chiral Lewis acids. Another field of application is C-C coupling reactions which are catalyzed by Lewis acids (M. Nakamura, S. Ito, K. Matsuo, E. Nakamura, Synlett. 2005, 11, 1794; A. Fürstner, G. Seidel, DE-A-10355169).

Solid halogen-containing Lewis acids are generally extremely corrosive and hygroscopic. For this reason, dosing these solids in chemical synthesis is problematic, since this must be carried out with exclusion of air and moisture. The adherence of these compounds to the materials used is likewise problematic, since corrosion and wear result. Lewis acids are hydrolyzed upon contact with water or atmospheric moisture, with release of hydrogen halide. The hydrolysis products reduce the yield of the reactions and interfere with secondary reactions, for example by reducing the stereoselectivity, and must be laboriously removed. It is also disadvantageous that the finely powdered solids may result in burning of the mucous membranes and respiratory tract in humans.

It is known that halogen-containing Lewis acids dissolve in high concentrations in diethyl ether. For example, the solubility of aluminum trichloride in diethyl ether at 25° C. is approximately 55 weight percent (% by weight), and for zinc dichloride the solubility at 25° C. is approximately 50% by weight.

The use of diethyl ether on the commercial scale is problematic due to its low boiling point (34.6° C.) and the associated high vapor pressure (443 mm Hg, 20° C.), the low flash point (−40° C.), the low ignition temperature (160° C.), and the high explosivity (lower explosion limit 1.8%, upper explosion limit 48%). It is also disadvantageous that diethyl ether tends to form highly explosive peroxides.

In tetrahydrofuran (THF), however, the solubility of halogen-containing Lewis acids is often low. Very large volumes must be used for a reaction, which minimizes the space-time yield and makes the synthesis uneconomical. The solubility of zinc dichloride in THF at 25° C., for example, is only approximately 20% by weight.

With solvents containing more than one donor atom, Lewis acids form poorly soluble chelate complexes, or decompose. For example, aluminum trichloride with 1,2-dimethoxyethane (1,2-DME) forms an insoluble complex having the composition [(1,2-DME)₃Al] [Cl]₃. Attempts to dissolve aluminum trichloride in diethoxymethane result in decomposition of the solvent with formation of ethoxychloromethane. In 1,2-DME, the solubility of zinc dichloride at 25° C. is only approximately 1% by weight.

The object of the present invention is to overcome the disadvantages of the prior art.

In particular, the object of the present invention is to provide concentrated solutions of Lewis acids in an aprotic, oxygen donor-containing solvent or mixtures thereof with hydrocarbons, which overcome the disadvantages of the prior art. A further object of the invention is to provide solutions of Lewis adds in aprotic, oxygen donor-containing solvents or mixtures thereof with hydrocarbons, in which these compounds, predominantly in the monomeric form, dissolve in a high percentage. A further object of the invention is to provide solutions of Lewis adds in oxygen donor-containing solvents or mixtures thereof with hydrocarbons, which have poor miscibility with water.

According to the invention, the object is achieved, surprisingly, by Lewis acids which are dissolved in aprotic, asymmetrically substituted, oxygen donor-containing solvents of general formula I:

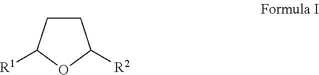

where the following apply: R¹≢R² and R¹, R² independently stand for H, or a functionalized or nonfunctionalized branched or unbranched alkyl, alkyloxy, cycloalkyl, or cycloalkyloxy group containing 1 to 20 C atoms, or an aryl or an aryloxy group containing 1 to 12 C atoms. For the case that R¹=H, R²≢H.

The following are examples of R¹ and R²: H, methyl, methoxy, methylmethoxy, ethyl, ethoxy, methylethoxy, n-propyl, propoxy, methylpropoxy, isopropyl, n-butyl, 2-butyl, isobutyl, tert-butyl, n-pentyl, isopentyl, neopentyl, tert-pentyl, hexyl, n-heptyl, isoheptyl, n-octyl, isooctyl, 2-ethyl-1-hexyl, 2,2,4-trimethylpentyl, nonyl, decyl, dodecyl, n-dodecyl, cyclopentyl, cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, pentafluorophenyl, phenoxy, methoxyphenyl, benzyl, mesityl, neophyl, thenyl, trimethylsilyl, triisopropylsilyl, tri(tert-butyl)silyl), and dimethylthexylsilyl. R¹=methyl and R²=H (tetrahydro-2-methylfuran (2-MeTHF)) are particularly preferred.

Surprisingly, it has been found that Lewis acids also dissolve in high concentrations in mixtures of solvents according to the invention with hydrocarbons, for example benzene, toluene, ethylbenzene, m-xylene, p-xylene, o-xylene, cyclohexane, heptane, n-hexane, methylcyclohexane, or cumene, preferably toluene.

The aprotic, asymmetrically substituted, oxygen donor-containing solvents according to the invention or mixtures thereof with hydrocarbons are characterized by an exceptional solubilizing power for Lewis acids, in particular halogen-containing Lewis acids.

Within the meaning of the invention, Lewis acids are molecules, salts, or ions which are able to act with respect to other particles, forming a covalent bond as electron pair acceptor. Halides of groups 8, 12, and 13 of the periodic table of the elements are preferred, and the chlorides of boron, zinc, and iron are particularly preferred.

The aprotic, asymmetrically substituted, oxygen donor-containing solvents according to the invention are also characterized by a higher boiling point compared to diethyl ether. The danger of forming an explosive atmosphere when used on the commercial scale is thus reduced. Tetrahydro-2-methylfuran, for example, has a boiling point of 77° to 79° C.

Another advantage of the solutions according to the invention of Lewis acids in aprotic, asymmetrically substituted, oxygen donor-containing solvents or in mixtures with hydrocarbons is that, for example, lithium halides or also magnesium halides are only sparingly soluble in these solvents. Thus, for example, the solubility of lithium chloride in tetrahydro-2-methylfuran at 25° C. is only 0.05 mmol/g. This is important, in that, for example, lithium or magnesium halides result from halogen-containing Lewis acids in the preparation of organometallic compounds, metal-hydrogen compounds, or elemental hydrogen compounds, and a simpler workup of the reaction mixture, for example by filtering, decanting, or centrifuging, is possible due to the low solubility of these halides. In THF the solubility of lithium chloride is much higher, at 1.14 mmol/g. Therefore, the workup and preparation of low-LiCl product solutions is complicated in THF.

The solutions of Lewis acids according to the invention are generally obtained as follows.

According to the invention, the aprotic, asymmetrically substituted, oxygen donor-containing solvent or mixtures of aprotic, asymmetrically substituted, oxygen donor-containing solvents according to the invention with hydrocarbons is/are placed in a reactor. A Lewis acid is introduced, either in one portion or in multiple portions, or by continuous conveying, for example via a screw conveyor, with stirring. Stirring is subsequently carried out until the necessary quantity of Lewis acid has dissolved, or until all of the Lewis acid has dissolved.

In another embodiment according to the invention, a Lewis acid is provided, and the aprotic, asymmetrically substituted, oxygen donor-containing solvent or mixture thereof with hydrocarbons, or, separately from another, an aprotic, asymmetrically substituted, oxygen donor-containing solvent and hydrocarbons, is/are added and stirred until the desired quantity of Lewis acid has dissolved, or until all of the Lewis acid has dissolved.

Undissolved solid fractions are preferably removed by decanting, centrifuging, or filtering.

The method is preferably carried out at temperatures between 78° C. and the boiling point of the solvent or the solvent mixture.

An oxygen donor-containing solvent or a mixture of an oxygen donor-containing solvent and a hydrocarbon are preferably used.

When a mixture of an aprotic, asymmetrically substituted, oxygen donor-containing solvent and hydrocarbon is used, the proportion of hydrocarbon in the product solution is preferably between 0.1% by weight and 70% by weight.

The operations preferably take place with exclusion of air in an inert gas atmosphere, preferably in an Ar or N₂ atmosphere.

The solutions according to the invention are suitable for use in synthesis chemistry, organic chemistry, and organometallic chemistry, in particular for the following:
Lewis acid-catalyzed reactions;
Friedel-Crafts alkylations and acylations;
Aldol reactions;
Diels-Alder reactions;
Salt elimination reactions;
Transmetallation reactions;
Reactions with metal-hydrogen compounds and elemental hydrogen compounds, and
When ZnCl₂-containing solutions for used for preparing Zn(BH₄)₂.

The invention is explained below with reference to examples, without being limited thereto.

### General Procedure:

The solvent is introduced into a reactor under an inert gas atmosphere. Due to the exothermic nature of the dissolution process, the Lewis acid salt is added in portions, with stirring, under inert gas conditions at the indicated temperatures. Technical salts and solvents were used.

### EXAMPLE 1

### Preparation of a Saturated 40% Solution of ZnCl₂ in 2-MeTHF

Weigh-in: ZnCl₂: 25.0 g; 2-MeTHF: 37.5 g;

Addition at 0° C. to 15° C., secondary reaction at 25° C.;

The resulting suspension was clear-filtered and analyzed;

Analytical: [Zn²⁺]=2.92 mmol/g; [Cl⁻]=5.84 mmol/g;

### EXAMPLE 2

### Preparation of a 26% Solution of ZnCl₂ in 2-MeTHF

Weigh-in: ZnCl₂: 25.0 g; 2-MeTHF: 71.2 g;

Addition at 0° C. to 15° C., secondary reaction at 25° C.;

The resulting solution was analyzed;

Analytical: [Zn²⁺]=1.90 mmol/g; [Cl⁻]=3.91 mmol/g;

Karl-Fischer water content: 0.04%.

### EXAMPLE 3

### Preparation of a 45% Solution of ZnBr₂ in 2-MeTHF

265 g MeTHF (water content 120 ppm) was placed in an inerted glass reactor and cooled to approximately 10° C. 217 g zinc bromide was added via a dosing bulb over a period of approximately 20 min, with stirring. The mixture was subsequently heated to approximately 25° C. and stirred for an additional hour.

The slightly opaque solution was clear-filtered.

Weigh-out: 465 g of a light yellowish, clear solution

ZnBr₂ content: 45.1% (yield 97% of theoretical)

### EXAMPLE 4

### Preparation of a Saturated 50% Solution of FeCl₃ Solutions in 2-MeTHF

Weigh-in: FeCl₃: 25.0 g; 2-MeTHF: 25.0 g;

Addition at 0° C. to 15° C., secondary reaction at 25° C.;

The resulting solution was analyzed;

Analytical: [Fe³⁺]=3.1 mmol/g; [Cl⁻]=9.3 mmol/g

### EXAMPLE 5

### Preparation of a 25% Solution of FeCl₃ Solutions in 2-MeTHF

Weigh-in: FeCl₃: 25.0 g; 2-MeTHF: 75.0 g;

Addition at 0° C. to 15° C., secondary reaction at 25° C.;

The resulting solution was analyzed;

Analytical: [Fe³⁺]=1.57 mmol/g; [Cl⁻]=4.70 mmol/g;

Karl-Fischer water content: 0.16%.

TABLE 1
Summary of examples, crystallization characteristics of the
solutions as a function of the solvent, and comparative examples

| Ex- | | | | | | | |
|---|---|---|---|---|---|---|---|
| am- | | | % by | Crystallized? (Yes +/No −) | | | |
| ple | Substance | Solvent | weight | 25° C. | 5° C. | 0° C. | −10° C. |
| 1 | ZnC1₂ | 2-MeTHF | 40 | − | + | + | + |
| 2 | ZnCl₂ | 2-MeTHF | 26 | − | − | − | − |
| | ZnCl₂* | THF | 20 | − | n.a. | + | + |
| | ZnCl₂* | THF | 15 | − | n.a. | + | + |
| | ZnCl₂* | Et₂O | 50 | − | n.a. | + | + |
| 4 | FeCl₃ | 2-MeTHF | 50 | − | + | + | + |
| 5 | FeCl₃ | 2-MeTHF | 25 | − | − | − | + |

*Comparative example; n.a. = not analyzed

1-13. (canceled)

14. A solution comprising at least one Lewis acid selected from the group consisting of a halogen-containing Lewis acid of an element of group 8, group 12, and group 13 of a periodic table of the elements, wherein the Lewis acid is dissolved in an aprotic, asymmetrically substituted, oxygen donor-containing solvent.

15. The solution according to claim 14, wherein the Lewis acid is dissolved in an asymmetrically substituted ether or a mixture of two or more asymmetrically substituted ethers, the proportion of the Lewis acid in the solution being between 10 and 70% by weight, preferably between 20 and 55% by weight.

16. A solution according to claim 14, wherein the Lewis acid is dissolved in a mixture of an asymmetrically substituted ether and a hydrocarbon, the proportion of the Lewis acid in the solution being between 10 and 70% by weight.

17. A solution according to claim 14, wherein the Lewis acid is a halide of an element selected from the group consisting of zinc, boron and iron.

18. A solution according to claim 14, wherein the Lewis acid is selected from the group consisting of zinc dichloride, zinc dibromide, iron dichloride and iron trichloride.

19. A solution according to claim 14, wherein the content of protic impurities is between 0 and 10 mol-%.

20. A solution according to claim 19, wherein the content of protic impurities is between 0.001 and 5 mol-%.

21. A solution according to claim 14, wherein the asymmetrically substituted ether is a compound of formula I, wherein
R¹ is not the same as R² and
wherein R¹, R² are independently selected from H, or a functionalized or nonfunctionalized branched or unbranched alkyl, alkyloxy, cycloalkyl, or cycloalkyloxy group containing 1 to 20 C atoms, or an aryl or an aryloxy group containing 1 to 12 C atoms.

22. A solution according to claim 21, wherein R¹ and R² are independently selected from the group consisting of methyl, methoxy, methylmethoxy, ethyl, ethoxy, methylethoxy, n-propyl, propoxy, methylpropoxy, isopropyl, n-butyl, 2-butyl, isobutyl, tert-butyl, n-pentyl, isopentyl, neopentyl, tert-pentyl hexyl, n-heptyl, isoheptyl, n-octyl, isooctyl, 2-ethyl-1-hexyl, 2,2,4-trimethylpentyl, nonyl, decyl, dodecyl, n-dodecyl, cyclopentyl cyclohexyl, cycloheptyl, methylcyclohexyl, vinyl, 1-propenyl, 2-propenyl, naphthyl, anthranyl, phenanthryl, o-tolyl, p-tolyl, m-tolyl, xylyl, ethylphenyl, mesityl, phenyl, pentafluorophenyl, phenoxy, methoxyphenyl, benzyl, mesityl, neophyl, thexyl, trimethylsilyl, triisopropylsilyl, tri(tert-butyl)silyl) and dimethylthexylsilyl.

23. A solution according to claim 21, wherein R¹ is methyl and R² is H.

24. A solution according to claim 14, wherein the asymmetrically substituted ether is tetrahydro-2-methylfuran.

25. A solution according to claim 24, wherein the solution further comprises a hydrocarbon.

26. A solution according to claim 25, wherein the hydrocarbon comprises at least one member selected from the group consisting of benzene, toluene, ethylbenzene, m-xylene, p-xylene, o-xylene, cyclohexane, heptane, n-hexane, methylcyclohexane, and cumene.

27. A solution according to claim 25, wherein the solution contains toluene as hydrocarbon.

28. A solution according to claim 25, wherein the content of the hydrocarbon in the product solution is between 0.1 and 70% by weight,

29. A method for preparing a solution comprising the steps of:
providing an aprotic, asymmetrically substituted, oxygen donor-containing solvent, and
adding a Lewis acid to the aprotic, asymmetrically substituted, oxygen donor-containing solvent.

30. A method for preparing a solution comprising the steps of:
providing a mixture of an aprotic, asymmetrically substituted, oxygen donor-containing solvent and a hydrocarbon, and
adding a Lewis acid to the mixture.
